(19) United States
(12) Patent Application Publication
(10) Pub. No.: US 2007/0257467 A1
(43) Pub. Date: Nov. 8, 2007

(54) Bicycle

(76) Inventor: Louis CHUANG, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/741,819

(22) Filed: Apr. 30, 2007

(30) Foreign Application Priority Data
May 2, 2006 (TW) 95115659

(51) Int. Cl. B62K 13/00

(52) U.S. Cl. 280/292; 280/288

(57) ABSTRACT

There is disclosed a bicycle to which a trailer can be connected and from which the trailer can be detached without jeopardizing the integrity thereof. The bicycle includes a frame and two hooks. The frame includes two rear ends. Each of the hooks includes a first end detachably connected to a related one of the rear ends of the frame and a second end for connection to the trailer. A positioning device is used to precisely position each of the hooks with respect to a related one of the rear ends of the frame.

### BACKGROUND OF INVENTION

1. Field of Invention

The present invention relates to a bicycle to which a trailer can be connected and from which the trailer can be detached without jeopardizing the integrity thereof

2. Related Prior Art

Referring to FIGS. 1 and 2, a conventional bicycle 1 includes a frame 2 and two hooks 3 for connecting a trailer to the frame 2. The frame 2 includes a head tube 6, a top tube 7 connected to the head tube 6, a down tube 8 connected to the head tube 6, a seat tube 9 connected to both of the tubes 7 and 8, a seat stay 10 connected to the seat tube 9 and a chain stay 11 connected to the seat tube 9. The seat stay 10 includes two branches each including a first end connected to the seat tube 9. The chain stay 11 includes two branches each including a first end connected to the seat tube 9. A second end of each of the branches of the seat stay 10 is joined to a second end of a related one of the branches of the chain stay 11 by a rear end 12 of the frame 2. Each of the rear ends 12 of the frame 2 includes a recess 14 defined therein within upper and lower walls and a cutout 15 defined therein within the recess 14.

A connector 13 is located between the rear ends 12 of the frame 2. The connector 13 includes a hub 131 formed thereon and a tunnel 16 defined therein. Each of the hooks 3 includes an aperture 19 defined in a first end 17 and a hook tip 20 formed at a second end 18. The first ends 17 of the hooks 3 are disposed in the recesses 14 of the rear ends 12 of the frame 2. A shaft 5 is inserted through the tunnel 16 of the connector 13. The shaft 5 includes two threaded ends inserted through the cutouts 15 of the rear ends 12 of the frame 2 and the apertures 19 of the hooks 3. Each of the threaded ends of the shaft 5 is driven in a screw hole 21 defined in a nut 4 so that the hooks 3 are connected to rear ends 12 of the frame 2. The trailer includes two rods each including a recess defined therein for receiving the hook tip 20 of a related one of the hooks 3 so that the trailer is connected to the frame 2.

The integrity of the bicycle 1 might be jeopardized during the connection of the hooks 3 to the frame 2 for several reasons.

Firstly, the hooks 3 are accessories that cannot be connected to the frame 2 without detaching the nuts 4 from the threaded ends of the shaft 5. The nuts 4 are engaged with the threaded ends of the shaft 5 again after the threaded ends of the shaft 5 are inserted through the apertures 19 of the hooks 3. The engagement of the nuts 4 with the threaded ends of the shaft 5 might not be done properly so that the shaft 5 and a rear wheel might be detached from the frame 2. This is however undesirable.

Secondly, the connection of the hooks 3 to the frame 2 inevitably increases the vibration of the bicycle 1. This increased vibration contributes to the disengagement of the nuts 4 from the shaft 5 and therefore the detachment of the rear wheel from the frame 2.

Thirdly, the hooking of the trailer by the hooks 3 inevitably causes one of the hooks 3 to pivot in a wrong direction and contribute to the disengagement of the related nut 4 from the shaft 5.

Fourthly, the hooks 3 are not supported from below by any portions of the rear ends 12 of the frame 2.

The present invention is therefore intended to obviate or at least alleviate the problems encountered in prior art.

### SUMMARY OF INVENTION

According to the present invention, a bicycle includes a frame and two hooks. The frame includes two rear ends. Each of the hooks includes a first end detachably connected to a related one of the rear ends of the frame and a second end for connection to the trailer. A positioning device is used to precisely position each of the hooks with respect to a related one of the rear ends of the frame.

The primary advantage of the bicycle according to the present invention is that the integrity thereof will not be jeopardized during the connection of the hooks to the rear ends and the detachment of the hooks from the rear ends.

Other objectives, advantages and features of the present invention will become apparent from the following description referring to the attached drawings.

### BRIEF DESCRIPTION OF DRAWINGS

The bicycle according to the present invention will be described via the detailed illustration of four embodiments in comparison with a conventional bicycle referring to the drawings wherein:

FIG. 1 is a perspective partial view of a conventional bicycle;

FIG. 2 is an exploded view of the bicycle shown in FIG. 1;

FIG. 3 is a perspective partial view of a bicycle according to the first embodiment of the present invention;

FIG. 4 is an exploded view of the bicycle shown in FIG. 3;

FIG. 5 is a perspective view of a trailer connected to the bicycle shown in FIG. 3;

FIG. 6 is a perspective view of the trailer detached from the bicycle shown in FIG. 3;

FIG. 7 is a perspective partial view of a bicycle according to the second embodiment of the present invention;

FIG. 8 is an exploded view of the bicycle shown in FIG. 7;

FIG. 9 is a perspective partial view of a bicycle according to the third embodiment of the present invention; and

FIG. 10 is a perspective partial view of a bicycle according to the fourth embodiment of the present invention.

### DETAILED DESCRIPTION OF EMBODIMENTS

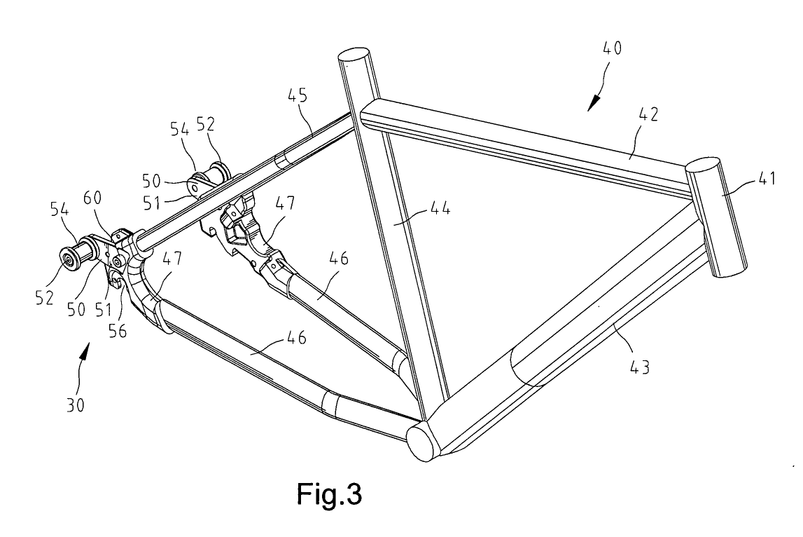

Referring to FIGS. 3 through 6, a trail 80 can be connected to and detached from a bicycle 30 according to a first embodiment of the present invention without jeopardizing the integrity of the latter. The bicycle 30 includes a frame 40, two hooks 50 for connecting the trailer 80 to the frame 40 and two fasteners 60 for attaching the hooks 50 to the frame 40.

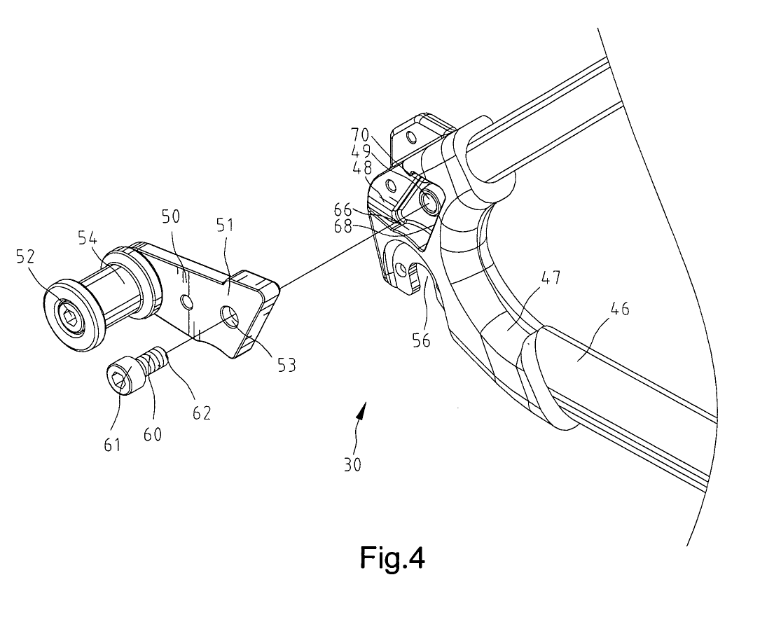

Referring to FIGS. 3 and 4, the frame 2 includes a head tube 41, a top tube 42 connected to the head tube 41, a down tube 43 connected to the head tube 41, a seat tube 44 connected to the tubes 42 and 43, a seat stay 45 connected to the seat tube 44 and a chain stay 46 connected to the seat tube 44. The seat stay 45 includes two branches each including a first end connected to the seat tube 44. The chain stay 46 includes two branches each including a first end connected to the seat tube 44. A second end of each of the branches of the seat stay 45 is joined to a second end of a related one of the branches of the chain stay 46 by a rear end 47. Each of the rear ends 47 includes a cutout 56 defined therein, a cavity 48 defined therein and a screw hole 49 defined therein within the cavity 48. The cavity 48 of each of the rear ends 47 of the frame 40 is defined by a lower wall 66, a front wall 68 and an upper wall 70.

Each of the hooks 50 includes an aperture 53 defined in a first end 51 and a hook tip 54 formed at a second end 52. The first end 51 of each of the hooks 50 is located in the cavity 48 of one of the rear ends 47 of the frame 40. The first end 51 of each of the hooks 50 is restrained by the walls 66, 68 and 70 of a related one of the rear ends 47 of the frame 40 and, more particularly, supported from below by the lower wall 66.

Each of the fasteners 60 includes a head 61 and a threaded body 62 extended from the head 61. The threaded body 62 of each of the fasteners 60 is driven into the screw hole 49 of a related one of the rear ends 47 through the aperture 53 of a related one of the hooks 50.

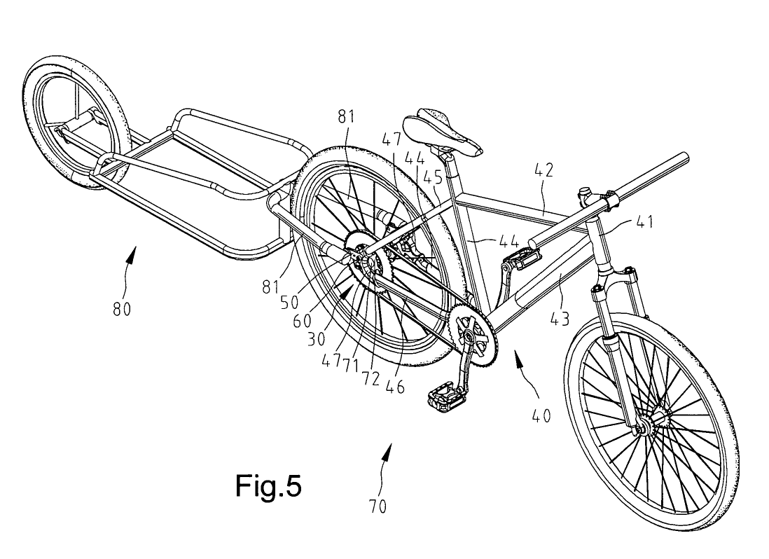

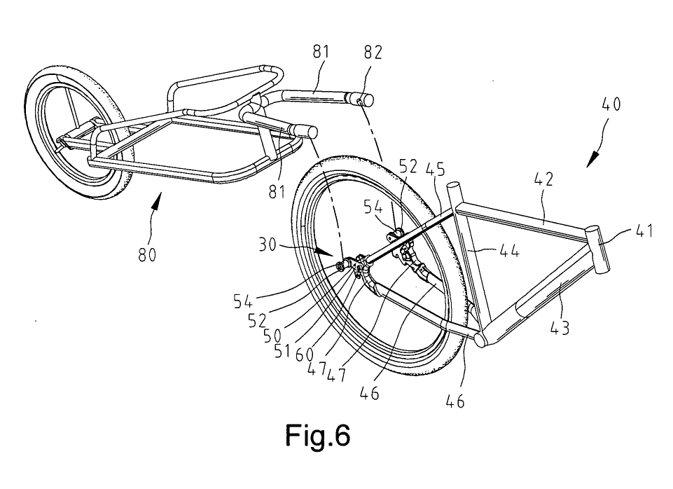

Referring to FIGS. 5 and 6, the trailer 80 includes two rods 81 each including a recess 82 defined therein for receiving the hook tip 54 of a related one of the hooks 50. Thus, the trailer 80 is detachably connected to the frame 40.

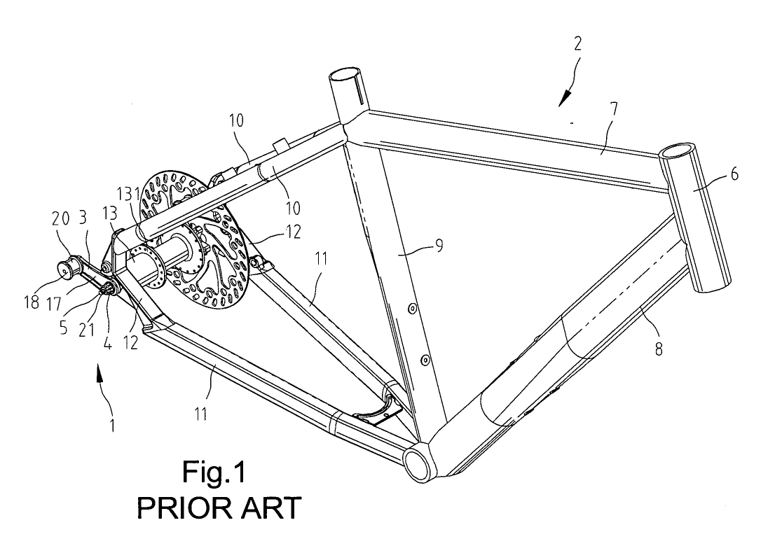

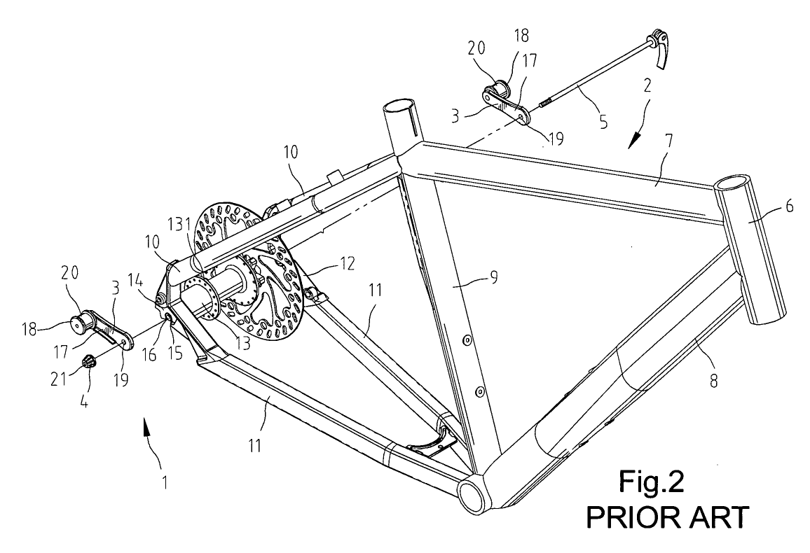

A connector such as the connector 13 shown in FIGS. 1 and 2 can be located between the rear ends 47. The connector includes a hub formed thereon and a tunnel defined therein. A shaft is inserted through the tunnel of the connector. The shaft include two threaded ends inserted through the cutouts 56 of the rear ends 47 and engaged with two nuts so that a rear wheel is connected to the rear ends 47.

It is clear that the connection of the hooks 50 to the rear ends 47 does not interfere with the connection of the shaft to the rear ends 47.

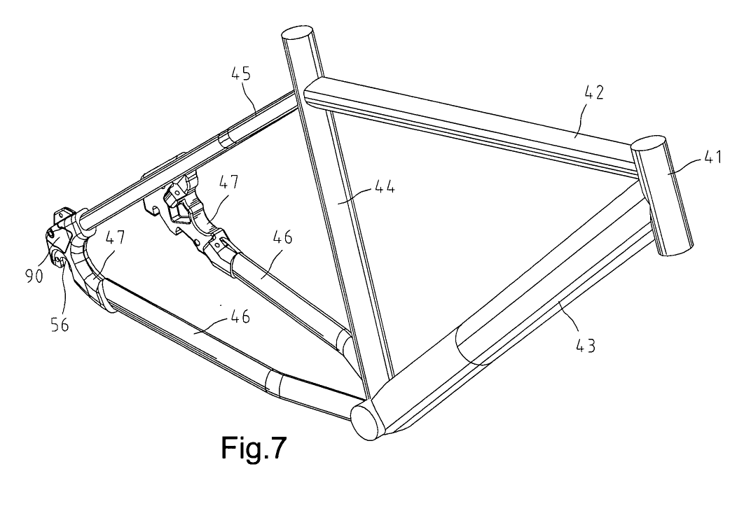

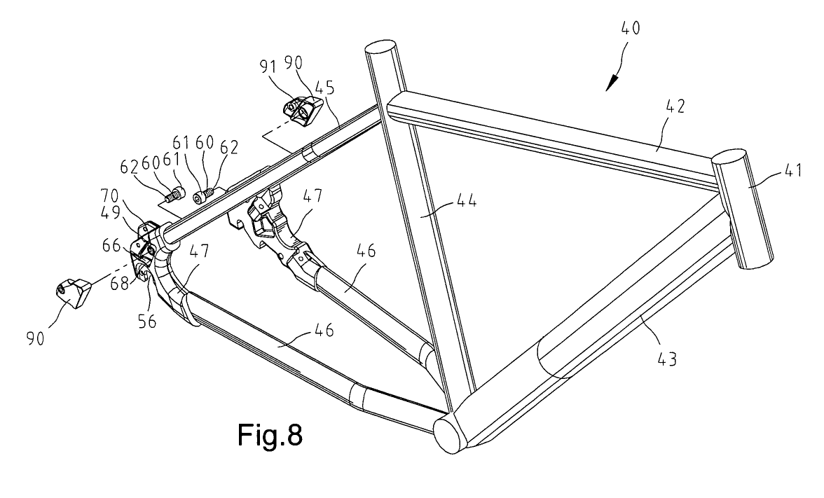

Referring to FIGS. 7 and 8, there is shown a bicycle according to a second embodiment of the present invention. The second embodiment is like the first embodiment except including two covers 90 for covering the cavities 48 and the fasteners 60 when then hooks 50 are detached from the rear ends 47. Therefore, the bicycle is aesthetically pleasing.

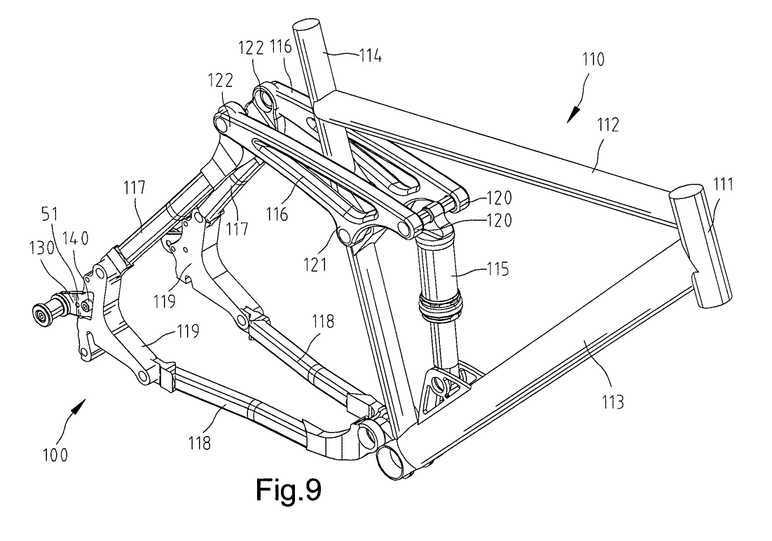

Referring to FIG. 9, according to a third embodiment of the present invention, a bicycle 100 includes a frame 110, two hooks 130 and two fasteners 140 for attaching the hooks 130 to the frame 110. The frame 110 includes a head tube 111, a top tube 112 connected to the head tube 111, a down tube 113 connected to the head tube 111 and a seat tube 114 connected to the tubes 112 and 113. A chain stay 118 includes two branches each including a first end connected to the seat tube 114 and a second end. There are two supporting elements 117 each including a first end and a second end connected to the second end of a related one of the branches of the chain stay 118 by a rear end 119. The rear ends 119 are similar to the rear ends 47. A cushion 115 is connected to the down tube 113. There are two rockers 116 each including a pivot 121 connected to the seat tube 114, a first end 120 connected to the cushion 115 and a second end 122 connected to the first end of a related one of the supporting elements 117. The hooks 130 are similar to the hooks 50. The fasteners 140 are similar to the fasteners 60.

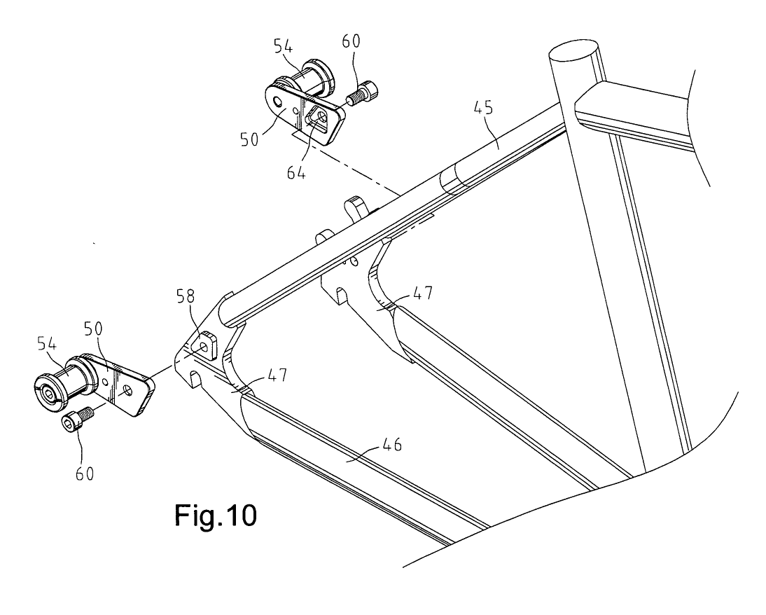

Referring to FIG. 10, there is a bicycle according to a fourth embodiment of the present invention. The fourth embodiment is like the first embodiment except two things. Firstly, each of the rear ends 47 is formed with a block 58 instead of the cavity 48. Secondly, each of the hooks 50 includes a cavity 64 defined therein for receiving a related one of the block 58.

The bicycle according to the present invention exhibits several advantages.

Firstly, the integrity of the bicycle will not be jeopardized during the connection of the hooks to the frame for several reasons. This is because the connection of the hooks to the frame does not interfere with the connection of the wheel to the frame.

Secondly, the connection of the hooks to the frame is convenient since the fasteners are easily operable.

Thirdly, the connection of the hooks to the frame is firm particularly because the hooks are supported from below by the lower walls of the cavities of the rear ends of the frame.

Fourthly, the frame is aesthetically pleasing for using the covers to cover the cavities and fasteners when the hooks are detached from the frame.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A bicycle comprising:
a frame comprising two rear ends each comprising a cavity defined therein;
two hooks each comprising a first end detachably attached to a related one of the rear ends of the frame and a second end for connection to a trailer; and
a positioning device for precisely positioning each of the hooks with respect to a related one of the rear ends of the frame.

2. The bicycle according to claim 1 wherein the frame comprises:
a head tube;
a top tube connected to the head tube;
a down tube connected to the head tube;
a seat tube connected to the top and down tubes;
a seat stay comprising two branches each including a first end connected to the seat tube and a second end connected to a related one of the rear ends of the frame; and
a chain stay comprising two branches each including a first end connected to the seat tube and a second end connected to a related one of the rear ends of the frame.

3. The bicycle according to claim 1 wherein the frame comprises:
a head tube;
a top tube connected to the head tube;
a down tube connected to the head tube;
a seat tube connected to the top and down tubes;
a chain stay comprising two branches each comprising a first end connected to the seat tube and a second end connected to a related one of the rear ends of the frame;
two supporting elements each comprising a first end and a second end connected to a related one of the rear ends of the frame;
a cushion connected to the down tube; and
two rockers each comprising a pivot connected to the seat tube, a first end connected to the cushion and a second end connected to a related one of the supporting elements.

4. The bicycle according to claim 1 comprising two fasteners for attaching the hooks to the rear ends of the frame.

5. The bicycle according to claim 4 wherein the fasteners are threaded bolts.

6. The bicycle according to claim 5 wherein each of the rear ends of the frame comprises a screw hole defined therein for receiving a related one of the threaded bolts.

7. The bicycle according to claim 5 wherein each of the hooks comprises an aperture defined in the first end thereof for receiving a related one of the threaded bolts.

8. The bicycle according to claim 1 wherein each of the hooks comprises a hook tip for insertion in a recess defined in a trailer so that the trailer is connected to the frame.

9. The bicycle according to claim 1 wherein the positioning device comprises a cavity defined in each of the rear ends of the frame for receiving the first end of each of the hooks.

10. The bicycle according to claim 9 wherein the cavity of each of the rear ends of the frame is defined by lower, front upper walls for supporting the first end of each of the hooks.

11. The bicycle according to claim 9 comprising a cover for covering the cavity of each of the rear ends of the frame.

12. The bicycle according to claim 1 wherein the positioning device comprises:
a block formed on each of the rear ends of the frame; and
a cavity defined in each of the hooks for receiving the block of a related one of the rear ends of the frame.
